(19) United States
(12) Patent Application Publication
(10) Pub. No.: US 2026/0288435 A1
(43) Pub. Date: Sep. 24, 2026

(54) SYSTEMS AND METHODS FOR DATA PACKAGE GENERATION IN DEPLOYMENT ENVIRONMENTS USING ARTIFICIAL INTELLIGENCE

(71) Applicant: BANK OF AMERICA CORPORATION, Charlotte, NC (US)

(72) Inventors: Jyothi Gaddam, Hyderabad (IN); Jenisa Nazareth Dias, Vasai West (IN); Rama Venkata S. Kavali, Frisco, TX (US); Venugopala Rao Randhi, Hyderabad (IN); Chenchi Saraswathi, Hyderabad (IN)

(73) Assignee: BANK OF AMERICA CORPORATION, Charlotte, NC (US)

(21) Appl. No.: 19/082,400

(22) Filed: Mar. 18, 2025

(51) Int. Cl. G06F 8/60; G06F 8/71

(52) U.S. Cl. CPC G06F 8/60; G06F 8/71

(57) ABSTRACT

Systems, computer program products, and methods are described herein for data package generation in deployment environments using AI. The present disclosure is configured to execute a code version control protocol on one or more code repositories and determine one or more application modules modified by the code version control protocol. Also, the present disclosure is configured to execute, using an AI engine, a deployment environment data scan based on the code version control protocol, wherein the deployment environment data scan comprises deployment environment data, and execute a data mapping matrix protocol based on the code version control protocol and the deployment environment data scan. The present disclosure is configured to execute, using the AI engine, a data deployment package protocol based on the data mapping matrix protocol, wherein the data deployment package protocol comprises a data deployment package, and transmit the data deployment package to one or more deployment environments.

### TECHNOLOGICAL FIELD

Example embodiments of the present disclosure relate to data package generation in deployment environments using artificial intelligence (AI).

### BACKGROUND

Increasingly complex and interconnected deployment environments comprise a network of application modules, databases, and interfaces. When preparing code changes to application modules, databases, and interfaces in a continuous-release programming framework, effective testing in a non-production deployment environment is critical to ensuring deployment environment continuity, application performance consistency, and data integrity. However, the complexity of deployment environments requires understanding in-depth how new code changes may impact the complex network of application modules, databases, and interfaces. In addition, monitoring code changes and identifying and mapping dependencies between application modules further adds complexities and complications. Accumulating required data from databases in a higher-level deployment environment to transmit into a lower-level environment for testing and validation is challenging, requires manual intervention, and necessitates preparing oversized datasets. The preparation of oversized datasets consumes excessive technical bandwidth within a deployment environment, increases lead times to testing the proposed code changes, frequently includes stale data, and requires ever-increasing repositories, which are challenging to restore to a lower-level deployment environment. Additional issues include failing to use proper data to test identified testing scenarios based on the proposed code changes, such as when deployment environment datasets are out of sync.

Applicant has identified a number of deficiencies and problems associated with data package generation in deployment environments using artificial intelligence. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for data package generation in deployment environments using artificial intelligence.

In one aspect, a system for data package generation in deployment environments using AI is provided. In some embodiments, the system may comprise a memory device with computer-readable program code stored thereon; at least one processing device, wherein executing the computer-readable program code is configured to cause the at least one processing device to execute the computer-readable program code to: execute a code version control protocol on one or more code repositories; determine one or more application modules modified by the code version control protocol; execute, using an AI engine, a deployment environment data scan based on the code version control protocol, wherein the deployment environment data scan comprises deployment environment data; execute a data mapping matrix protocol based on the code version control protocol and the deployment environment data scan; execute, using the AI engine, a data deployment package protocol based on the data mapping matrix protocol, wherein the data deployment package protocol comprises a data deployment package; and transmit the data deployment package to one or more deployment environments.

In some embodiments, the code version control protocol comprises: receiving a code version control protocol request; determining code package deployments based on a code release schedule; monitoring the one or more code repositories for changed code; and detecting new code packages based on at least one of the code version control protocol request, code package deployments, and the new code packages.

In some embodiments, the deployment environment data scan further comprises: scanning, using the AI engine, one or more datasets associated with the one or more application modules, wherein the AI engine comprises a generative AI model; identifying, using the AI engine, internal data repository code changes based on the code version control protocol; and determining, using the AI engine, code execution procedures from memory, error logs associated with deployment environment failures, and metadata associated with deployment environment failures.

In some embodiments, the data mapping matrix protocol comprises: determining one or more records modified by the one or more application modules targeted by the code version control protocol; generating a data mapping matrix; and populating the data mapping matrix with matrix data, wherein the matrix data comprises an identifier associated with the one or more application modules and a descriptor associated with the code version control protocol.

In some embodiments, executing the computer-readable program code is further configured to cause the at least one processing device to: identify one or more frameworks associated with the one or more application modules; determine one or more missing frameworks associated with the one or more application modules; transmit a framework request associated with the one or more missing frameworks; and generate, using the AI engine, one or more new frameworks associated with the one or more application modules based on the framework request.

In some embodiments, executing the computer-readable program code is further configured to cause the at least one processing device to: receive one or more additional data deployment package requests; generate, using the AI engine, one or more additional deployment datasets; generate, using the AI engine, one or more additional data deployment packages; and transmit the one or more additional data deployment packages to the one or more deployment environments.

In some embodiments, executing the computer-readable program code is further configured to cause the at least one processing device to: generate a user interface on a display; render one or more interactive interface elements within the user interface, wherein the one or more interactive interface elements within the user interface are associated with the code version control protocol, deployment environment data scan, data mapping matrix protocol, and data deployment package protocol; and receive control signals from at least one device to modify the one or more interactive interface elements.

In some embodiments, executing the computer-readable program code is further configured to cause the at least one processing device to: receive at least one historical dataset; train the AI engine based on the at least one historical dataset; receive network packet anomaly data; update the at least one historical dataset with the network packet anomaly data; and retrain the AI engine based on the network packet anomaly data.

In some embodiments, executing the computer-readable program code is further configured to cause the at least one processing device to: determine, using the AI engine, an anomaly associated with at least one of the code version control protocol, deployment environment data scan, data mapping matrix protocol, and data deployment package protocol; generate, using the AI engine, one or more anomaly remediations; and transmit the one or more anomaly remediations.

In some embodiments, the data deployment package protocol further comprises: determining, using the AI engine, a first dataset based on the data mapping matrix protocol and a threshold, wherein the first dataset comprises a subset of the deployment environment data associated with the one or more application modules modified by the code version control protocol; determining a second dataset based on the one or more application modules and the first dataset, wherein the second dataset comprises the deployment environment data modified in at least two of the one or more application modules and deployment environment error data; identifying a third dataset associated with the second dataset; selecting a deployment environment dataset based on a reference matrix, the first dataset, the second dataset, and the third dataset; and generating and executing a query, using the AI engine, to generate the deployment data package based on the deployment environment dataset.

In another aspect, a computer program product for data package generation in deployment environments using AI, wherein the computer program product comprises at least one non-transitory computer-readable medium having computer-readable program code portion embodied therein, the computer-readable program code portions which when executed by a processing device are configured to cause a processor to: execute a code version control protocol on one or more code repositories; determine one or more application modules modified by the code version control protocol; execute, using an AI engine, a deployment environment data scan based on the code version control protocol, wherein the deployment environment data scan comprises deployment environment data; execute a data mapping matrix protocol based on the code version control protocol and the deployment environment data scan; execute, using the AI engine, a data deployment package protocol based on the data mapping matrix protocol, wherein the data deployment package protocol comprises a data deployment package; and transmit the data deployment package to one or more deployment environments.

In some embodiments, the code version control protocol comprises: receiving a code version control protocol request; determining code package deployments based on a code release schedule; monitoring the one or more code repositories for changed code; and detecting new code packages based on at least one of the code version control protocol request, code package deployments, and the new code packages.

In some embodiments, the deployment environment data scan further comprises: scanning, using the AI engine, one or more datasets associated with the one or more application modules, wherein the AI engine comprises a generative AI model; identifying, using the AI engine, internal data repository code changes based on the code version control protocol; and determining, using the AI engine, code execution procedures from memory, error logs associated with deployment environment failures, and metadata associated with deployment environment failures.

In some embodiments, the data mapping matrix protocol comprises: determining one or more records modified by the one or more application modules targeted by the code version control protocol; generating a data mapping matrix; and populating the data mapping matrix with matrix data, wherein the matrix data comprises an identifier associated with the one or more application modules and a descriptor associated with the code version control protocol.

In some embodiments, the data deployment package protocol further comprises: determining, using the AI engine, a first dataset based on the data mapping matrix protocol and a threshold, wherein the first dataset comprises a subset of the deployment environment data associated with the one or more application modules modified by the code version control protocol; determining a second dataset based on the one or more application modules and the first dataset, wherein the second dataset comprises the deployment environment data modified in at least two of the one or more application modules and deployment environment error data; identifying a third dataset associated with the second dataset; selecting a deployment environment dataset based on a reference matrix, the first dataset, the second dataset, and the third dataset; and generating and executing a query, using the AI engine, to generate the deployment data package based on the deployment environment dataset.

In another aspect, a computer-implemented method for data package generation in deployment environments using AI: executing a code version control protocol on one or more code repositories; determining one or more application modules modified by the code version control protocol; executing, using an AI engine, a deployment environment data scan based on the code version control protocol, wherein the deployment environment data scan comprises deployment environment data; executing a data mapping matrix protocol based on the code version control protocol and the deployment environment data scan; executing, using the AI engine, a data deployment package protocol based on the data mapping matrix protocol, wherein the data deployment package protocol comprises a data deployment package; and transmitting the data deployment package to one or more deployment environments.

In some embodiments, the code version control protocol comprises: receiving a code version control protocol request; determining code package deployments based on a code release schedule; monitoring the one or more code repositories for changed code; and detecting new code packages based on at least one of the code version control protocol request, code package deployments, and the new code packages.

In some embodiments, the deployment environment data scan further comprises: scanning, using the AI engine, one or more datasets associated with the one or more application modules, wherein the AI engine comprises a generative AI model; identifying, using the AI engine, internal data repository code changes based on the code version control protocol; and determining, using the AI engine, code execution procedures from memory, error logs associated with deployment environment failures, and metadata associated with deployment environment failures.

In some embodiments, the data mapping matrix protocol comprises: determining one or more records modified by the one or more application modules targeted by the code version control protocol; generating a data mapping matrix; and populating the data mapping matrix with matrix data, wherein the matrix data comprises an identifier associated with the one or more application modules and a descriptor associated with the code version control protocol.

In some embodiments, the data deployment package protocol further comprises: determining, using the AI engine, a first dataset based on the data mapping matrix protocol and a threshold, wherein the first dataset comprises a subset of the deployment environment data associated with the one or more application modules modified by the code version control protocol; determining a second dataset based on the one or more application modules and the first dataset, wherein the second dataset comprises the deployment environment data modified in at least two of the one or more application modules and deployment environment error data; identifying a third dataset associated with the second dataset; selecting a deployment environment dataset based on a reference matrix, the first dataset, the second dataset, and the third dataset; and generating and executing a query, using the AI engine, to generate the deployment data package based on the deployment environment dataset.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for data package generation in deployment environments using AI, in accordance with an embodiment of the disclosure;

FIG. 2 illustrates an exemplary AI engine subsystem architecture, in accordance with an embodiment of the disclosure;

FIG. 3 illustrates an exemplary generative AI engine subsystem architecture, in accordance with an embodiment of the disclosure;

FIG. 4 illustrates a process flow for data package generation in deployment environments using AI, in accordance with an embodiment of the disclosure;

FIG. 5 illustrates a process flow for identifying and generating frameworks associated with the one or more application modules, in accordance with an embodiment of the disclosure;

FIG. 6 illustrates a process flow for generating one or more additional data deployment packages, in accordance with an embodiment of the disclosure;

FIG. 7 illustrates a process flow for rendering and modifying one or more interactive interface elements, in accordance with an embodiment of the disclosure;

FIG. 8 illustrates a process flow for training and retraining the AI engine, in accordance with an embodiment of the disclosure; and

FIG. 9 illustrates a process flow for determining anomalies and anomaly remediations using the AI engine, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships, or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface may include a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that may be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (e.g., distal phalanges, intermediate phalanges, proximal phalanges, and the like)), an answer to a security question, a unique intrinsic user activity (e.g., making a predefined motion with a user device), and/or the like. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources input by the plurality of users within the system. The system may further use its authentication servers to certify the identity of users of the system, such that other users may verify the identity of the certified users. In some embodiments, the entity may certify the identity of the other users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (e.g., rotationally coupled, pivotally coupled, or the like). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, source code, database query code, database objects, code packages, executables, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. For purposes of this disclosure, a resource is typically stored in a resource repository-a storage location where one or more resources are organized, stored, and retrieved electronically using a computing device.

As used herein, a “resource transfer,” “resource distribution,” or “resource allocation” may refer to any transactions, activities, or communications between one or more entities, or between the user and the one or more entities. A resource transfer may refer to any distribution of resources such as, but not limited to, code transmissions, network resources, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to account identifying information stored electronically in a user device, such as payment credentials or tokens/aliases associated with a digital wallet, or account identifiers stored by a mobile application.

Accordingly, the present disclosure is directed to data package generation in deployment environments using AI. The present disclosure is directed to monitor and detect code version changes in one or more code repositories. By monitoring code version requests and code package release schedules, as well as detecting coding changes and new code packages, the present disclosure is configured to determine when new datasets are required for testing the proposed code changes. Furthermore, the present disclosure is configured to determine one or more application modules modified by the code changes. By evaluating impacted application modules, the present disclosure may target changes in a deployment environment impacted by the revised code. The present disclosure also is configured to utilize an AI engine to execute a deployment environment data scan. The deployment environment data scan identifies one or more datasets associated with the impacted application modules. In determining which data in a higher-level deployment environment will be impacted by coding changes, the present disclosure is configured to identify relevant datasets for testing dynamically, efficiently, and in-real time.

In addition, the present disclosure is configured to determine records modified by the one or more application modules targeted by the code version control protocol, generate a data mapping matrix, and populate the data mapping matrix. The data mapping matrix facilitates understanding how the code revisions not only impacts application modules, but data, datasets, databases, and/or the like in a high-level deployment environment. Furthermore, the present disclosure is configured to generate and transmit a data deployment package, wherein the data deployment package comprises a minimum required testing dataset.

What is more, the present disclosure provides a technical solution to a technical problem. As described herein, the technical problem includes generating a dataset necessary for executing all test cases of code revisions to ensure application dependability, performance consistency, and data integrity, without relying upon oversized testing datasets that consume additional technical resources and overwhelm deployment environments. The technical solution presented herein allows for dynamic, scalable, efficient data package generation in deployment environments using AI, which minimizes required datasets for testing code revisions, reduces testing lead times, and accurately assesses data repositories, data records, and applications impacted by coding revisions. In particular, data package generation in deployment environments using AI is an improvement over existing solutions to the technical challenges, (i) with fewer steps to achieve the solution, thus reducing the amount of computing resources, such as processing resources, storage resources, network resources, and/or the like, that are being used (e.g., identifying subsets of all data in a higher-level deployment environment impacts by coding revisions to determine a minimized testing dataset), (ii) providing a more accurate solution to the problem, thus reducing the number of resources required to remedy any errors made due to a less accurate solution (e.g., by generating a data mapping matrix to identify linkages between application modules, data records, and the proposed code revisions), (iii) removing manual input and waste from the implementation of the solution, thus improving speed and efficiency of the process and conserving computing resources (e.g., utilizing an AI engine to scan the deployment environments to generate testing datasets automatically without manual analysis, intervention, or developer-generated datasets), (iv) determining an optimal amount of resources that need to be used to implement the solution, thus reducing network traffic and load on existing computing resources (e.g., utilizing AI for only including data records impacted across application modules in the testing dataset to reduce the testing dataset size). Furthermore, the technical solution described herein uses a rigorous, computerized process to perform specific tasks and/or activities that were not previously performed. In specific implementations, the technical solution bypasses a series of steps previously implemented, thus further conserving computing resources.

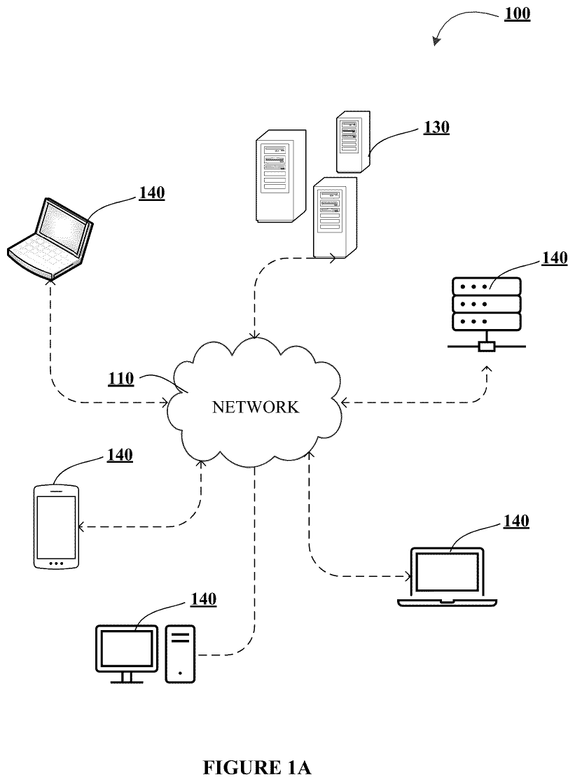

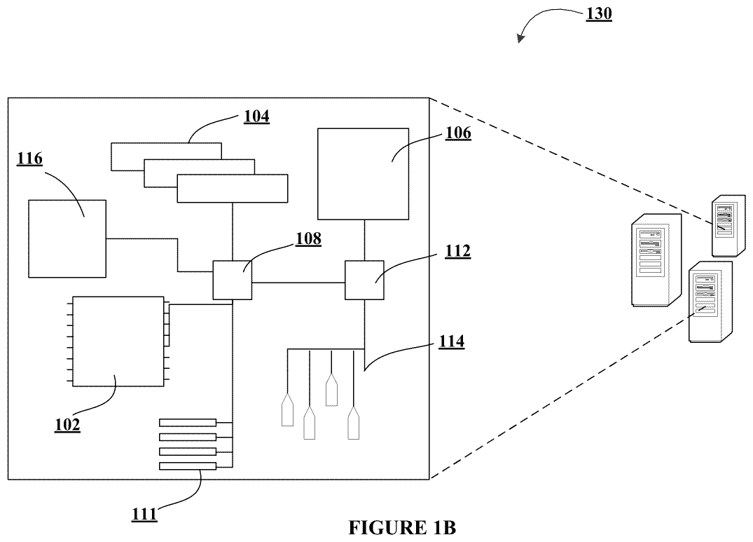

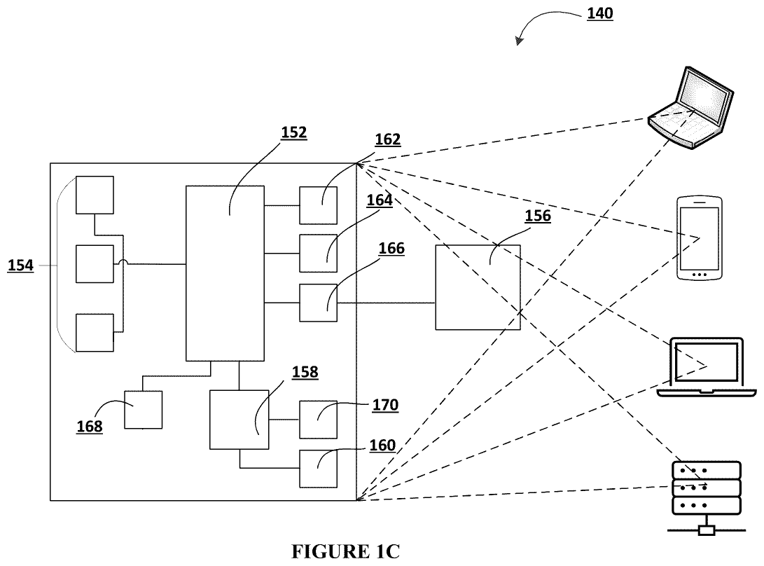

FIGS. 1A-1C illustrate technical components of an exemplary distributed computing environment for data package generation in deployment environments using AI 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connected to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which may be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low-speed bus 114 and storage device 106. Each of the components 102, 104, 106, 108, 112 and 114 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 130, while the low-speed interface/controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, the low-speed interface/controller 112 is coupled to storage device 106 and low-speed bus/expansion port 114. The low-speed bus/expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 166 may comprise appropriate circuitry and may be configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier may be a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through the communication interface 158, which may include digital signal processing circuitry where necessary. The communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, a GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using an audio codec 162, which may receive spoken information from a user and convert the spoken information to usable digital information. The audio codec 162 may likewise generate audible sound for a user, such as through a speaker (e.g., in a handset of end-point device(s) 140). Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described herein may be realized in digital electronic circuitry, integrated circuitry, specially designed ASICs (application specific integrated circuits), computer hardware, firmware, software, and/or combinations thereof.

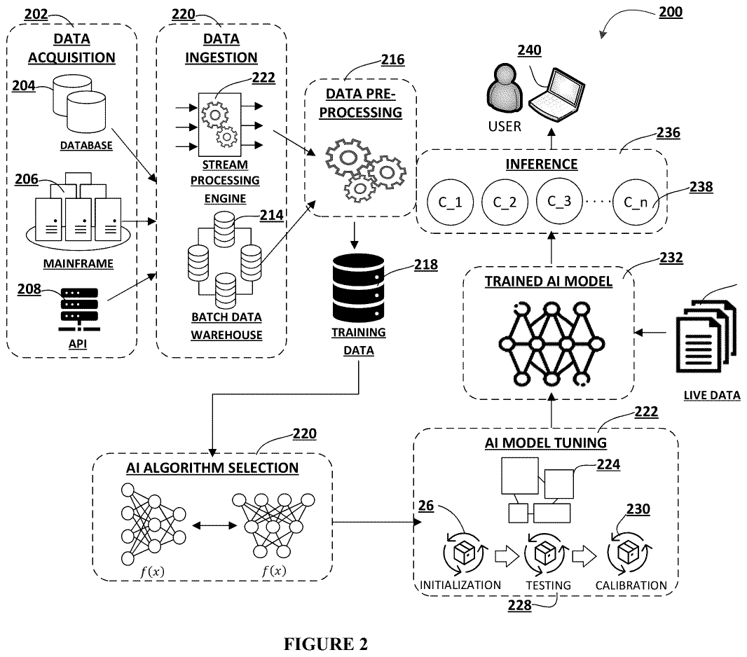

FIG. 2 illustrates an exemplary AI engine subsystem architecture 200, in accordance with an embodiment of the disclosure. The artificial intelligence subsystem 200 may include a data acquisition engine 202, data ingestion engine 210, data pre-processing engine 216, AI tuning engine 222, and inference engine 236.

The data acquisition engine 202 may identify various internal and/or external data sources to generate, test, and/or integrate new features for training the artificial intelligence model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including Rational Database Management Systems (RDBMs), other types of databases, Simple Storage System (S3) buckets, Comma Separated Values (CSVs), or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence model 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable artificial intelligence model type. Each of these types of artificial intelligence algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the artificial intelligence model, the Machine Learning (ML) model tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained artificial intelligence model 232 is one whose hyperparameters are tuned and model accuracy maximized.

The trained artificial intelligence model 232, similar to any other software application output, can be persisted to storage, file, memory, or application, or looped back into the processing component to be reprocessed. More often, the trained artificial intelligence model 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence models that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

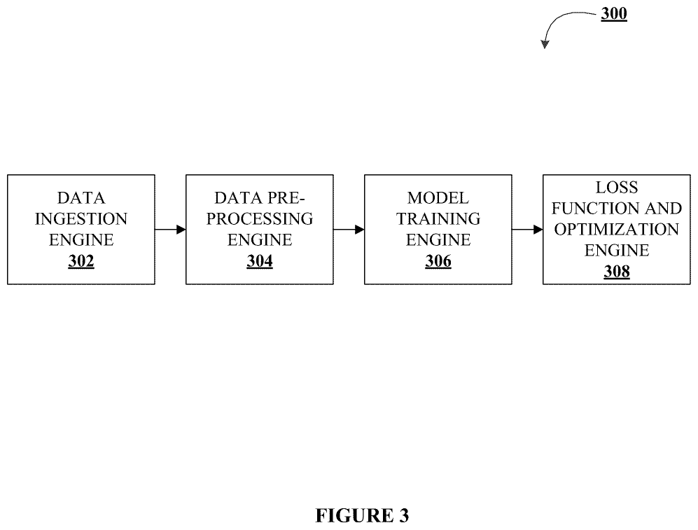

FIG. 3 illustrates an exemplary generative AI subsystem 300, in accordance with an embodiment of the invention. The generative AI subsystem 300 may include a data ingestion engine 302, a data pre-processing engine 304, and a model training engine 306. It should be understood that the generative AI subsystem 300 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the invention.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, or from streams. For a Large Language Model (LLM), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In Machine Learning (ML), the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some embodiments, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some embodiments, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training module 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some embodiments, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In embodiments involving large language models, the model training engine 306 may utilize transformer-based architectures, such as the Transformer, Bidirectional Encoder Representations from Transformers (BERT), Generative Pre-trained Transformer (GPT), or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to manage tasks such as summarization, translation, and text generation. Loss functions like cross-entropy loss may be used to optimize the model's performance by comparing predicted tokens with the actual tokens in the dataset to guide the model to minimize prediction errors during training, as described in further detail herein.

In embodiments involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or Recurrent Neural Networks (RNNs) like WaveNet, designed to manage sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL (Kullback-Liebler) divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306, which includes an optimization module 308, may implement various optimization techniques to improve model performance and efficiency. The optimization module 308 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 308 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some embodiments, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or Graphical Processing Units (GPUs), where each node processes a portion of the data and updates the model in parallel. This is particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 306 may also implement transfer learning, where a pre-trained model is fine-tuned on a smaller, domain-specific dataset. This may reduce the amount of time and data required to train a new model, especially in cases where the available data is limited or highly specialized. The model training engine 306 may adjust the parameters of the pre-trained model to better align with the new dataset, while preserving the learned features from the original training.

In embodiments involving LLMs, new output is generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters such as heat, which influences the randomness of the token sampling, enabling the generation of diverse or deterministic responses.

In image generation models, such as those using ViTs or GANs, new output is generated by sampling from the learned distribution in the model's latent space. For GANs, the generator network creates an image by transforming random noise vectors into structured image outputs through a series of layers that learn visual features like shapes, textures, and colors. The generated image is then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors, or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some embodiments, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the embodiment of the generative AI subsystem 300 illustrated in FIG. 3 is exemplary and that other embodiments may vary. The generative AI subsystem 300, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

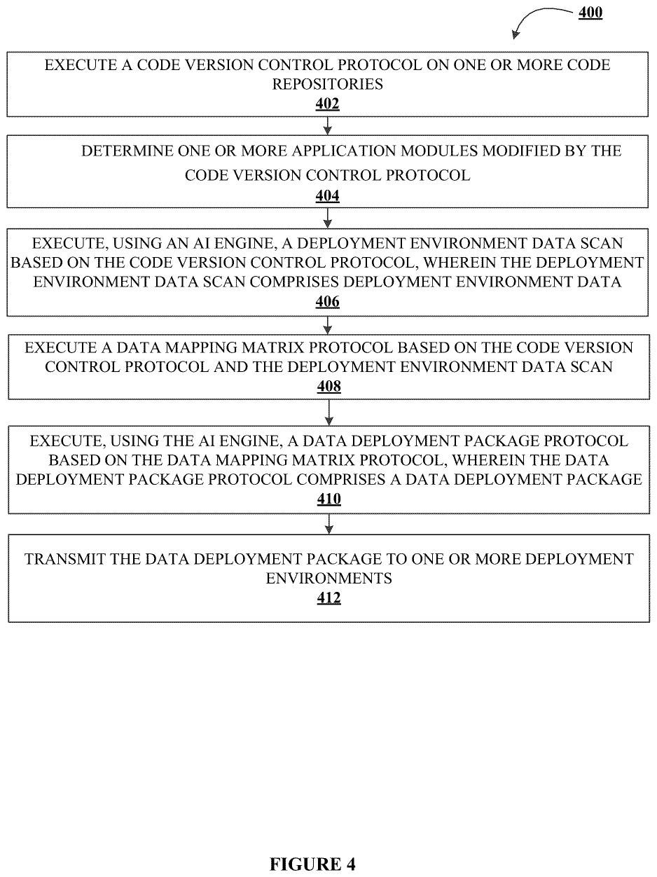

FIG. 4 illustrates a process flow 400 for data package generation in deployment environments using AI, in accordance with an embodiment of the disclosure. In some embodiments, a system (e.g., similar to one or more of the systems described herein with respect to FIGS. 1A-1C) may perform one or more of the steps of process flow 400. For example, data package generation in deployment environments using AI system (e.g., the system 130 described herein with respect to FIGS. 1A-1C) may perform the steps of process flow 400. In some embodiments, an AI engine (e.g., such as the AI engine like that described in FIG. 2) or a generative AI subsystem (e.g., such as the generative AI subsystem described in FIG. 3) may perform some or all of the steps described in process flow 400.

As shown in block 402, the process flow 400 may include the step of executing a code version control protocol on one or more code repositories. According to some embodiments, the code version control protocol may be executed by the AI engine. In some embodiments, the code version control protocol request may be transmitted by a code package deployment developer, change code author, database administrator, application programming interface (API), code repository server, and/or the like. The code version protocol request may comprise changed code, objects and/or executables associated with the change code, a description of the changed code, an identifier associated with the developer of the changed code, a requested deadline for completing the code version protocol request, a list of one or more application modules revised by the change code, a data mapping matrix (e.g., predetermined data mapping matrix and/or un-populated data mapping matrix), and/or one or more frameworks associated with the one or more application modules.

According to some embodiments, the code version control protocol may comprise determining code package deployments based on a code release schedule. The code release schedule may comprise a determined schedule for releasing new code revisions into a higher-level deployment environment. The determined schedule may comprise a requested deadline and/or mandatory deadline for implementing the revised code. Determining the code package deployments based on the code release schedule may comprise adding each scheduled code release into a queue, analyzing each scheduled code release (including, without limitation, via the AI engine) to determine a sequence of executing a plurality of code version control protocols, and executing each code version control protocol based on the prioritization. The prioritization may be based on mandatory and/or requested deadlines, security threat levels associated with the code revisions, required application module maintenance, and/or the like.

According to some embodiments, code version control protocol may comprise detecting new code packages based on at least one of the code version protocol request, code package deployments, and the new code packages. Detecting new code packages may comprise utilizing at least one source to determine whether new code packages have been generated. By way of non-limited example, and in some embodiments, the system and/or AI engine may receive code version protocol requests; evaluate code repositories for new code commitments, updated executables and/or objects associated with code, and/or scan repositories for modified coding files; and/or analyze the code release schedule for new code packages set for release into one or more deployment environments. In some embodiments, the code version control protocol may comprise at least one of receiving a code version control protocol request; determining code package deployments based on a code release schedule; monitoring the one or more code repositories for changed code; and detecting new code packages based on at least one of the code version protocol request, code package deployments, and the new code packages.

As shown in block 404, the process flow 400 may include the step of determining one or more application modules modified by the code version control protocol. According to some embodiments, the AI engine may scan code repositories, executables, coding files, and/or logs to determine the one or more applications modules modified by the code version control protocol, and/or the code version control protocol. In some embodiments, coding comments, functions, file names, and/or the like may identify the one or more application modules set for modifications based on the changed code. In some embodiments, the code version control protocol may identify the modified one or more application modules. The AI engine may evaluate the code version control protocol and execute a deployment environment scan of a deployment environment targeted by the code revisions to determine which one or more applications modules will be modified, according to some embodiments.

As shown in block 406, the process flow 400 may include the step of executing, using an AI engine, a deployment environment data scan based on the code version control protocol, wherein the deployment environment data scan comprises deployment environment data. In some embodiments, the deployment environment data scan comprises at least one of scanning, using the AI engine, one or more datasets associated with the one or more application modules, wherein the AI engine comprises a generative AI model and/or the one or more application modules are modified by code changes; identifying, using the AI engine, internal data repository code changes based on the code version control protocol; and determining, using the AI engine, code execution procedures from memory, error logs associated with deployment environment failures, and metadata associated with deployment environment failures. In some embodiments, the AI engine may scan the code revisions to determine changes impacting tuples, records, and/or the like.

As shown in block 408, the process flow 400 may include the step of executing a data mapping matrix protocol based on the code version control protocol and the deployment environment data scan. According to some embodiments, the AI engine may execute the data mapping matrix protocol. In some embodiments, the data mapping matrix protocol may comprise determining one or more records modified by the one or more application modules targeted by the code version control protocol. According to some embodiments, the AI engine may analyze records in a higher-level deployment environment (e.g., production-level, quality assurance/testing level, and/or the like) to identify tuples and/or data rows in one or more databases, data repositories, and/or tables associated with the that will be modified by the one or more application modules targeted by the code version control protocol. The AI engine may add the tuples and/or data rows to an intermediary data repository (e.g., staging table, intermediate database, and/or the like) for further data processing. According to some embodiments, the AI engine may evaluate these data to detect anomalies, such as corrupted data, data inserted by an unauthorized network device, null values, error values, and/or the like.

In some embodiments, the data mapping matrix protocol may comprise generating a data mapping matrix. The data mapping matrix may comprise a table comprising one or more rows and one or more columns, an intermediate data repository, and/or a legend for mapping and/or compiling data associated with the one or more application modules. The data mapping matrix may be predefined, defined dynamically in real-time by the AI engine, be generated in accordance with a defined template (e.g., predetermined headers), and/or the like. In some embodiments, the AI engine may generate the data mapping matrix based on code execution procedures from memory, error logs associated with deployment environment failures, and metadata associated with deployment environment failures. The data mapping matrix may require authentication in order to access and/or view data contained therein, wherein the authentication may comprise credentials, one-time password, physical factor authentication, multi-factor authentication, authentication application, network access controls, application access provisioning, token authentication, and/or the like.

In some embodiments, the data mapping matrix protocol may comprise populating the data mapping matrix with matrix data. In some embodiments, the system and/or AI engine may populate the data mapping in real-time, upon a dynamic trigger, continuously as network traffic flows, and/or at predetermined intervals. The data mapping matrix may require authentication in order to receive permission to edit the data mapping matrix, wherein the authentication may comprise one or more authorization methods (which may be determined dynamically via the AI engine based on security criteria, a security threshold associated with the code changes, and/or the like), such as via credentials, one-time password, physical factor authentication, multi-factor authentication, authentication app, network access controls, application access provisioning, token authentication, and/or the like.

In some embodiments, populating the data mapping matrix may comprise transmitting data from the intermediate data repository to the data mapping matrix. The data transmission may occur via an Extract, Transform, and Load (ETL) process, encrypted data packets, SSL, TCP/IP, communication linkage, and/or the like. In some embodiments, the matrix data may comprise an identifier associated with the one or more application modules (e.g., name of the or more application modules, description the or more application modules, and/or the like), a descriptor associated with the code version control protocol (e.g., description of code changes that will modify the or more application modules), a description of the one or more application modules'functionality, software version metadata, operating system metadata, programming languages associated with the code version control protocol, and/or the like. In some embodiments, the AI engine may determine and/or generate the matrix data based on the code version control protocol (e.g., matrix data generated during code version control protocol), deployment environment data scan (e.g., matrix data generated during deployment environment data scan), and/or the like.

In some embodiments, the data mapping matrix protocol may comprise at least one of determining one or more records modified by the one or more application modules targeted by the code version control protocol; generating a data mapping matrix; and/or populating the data mapping matrix with matrix data, wherein the matrix data comprises an identifier associated with the one or more application modules and a descriptor associated with the code version control protocol.

As shown in block 410, the process flow 400 may include the step of executing, using the AI engine, a data deployment package protocol based on the data mapping matrix protocol, wherein the data deployment package protocol comprises a data deployment package.

In some embodiments, the data deployment package protocol comprises determining, using the AI engine, a first dataset based on the data mapping matrix protocol and a threshold, wherein the first dataset comprises a subset of the deployment environment data associated with the one or more application modules modified by the code version control protocol. The subset of the deployment environment data associated with the one or more application modules modified by the code version control protocol may comprise one or more tuples and/or rows in one or more data repositories in a higher-level deployment environment associated with one or more one or more application modules modified by the code version control protocol.

In some embodiments, the threshold may indicate whether a threshold quantity of the one or more tuples and/or rows are flagged for further evaluation and potential inclusion in the data deployment package. In some embodiments, the threshold may be associated with a security criticality, part of a code revision control protocol request, and/or the like. In some embodiments, the first dataset may be determined even if a threshold is not met and/or exceeded, based on the data mapping matrix protocol. In some embodiments, the threshold may be predetermined, determined dynamically by the AI engine, and/or be determined via the code version control protocol.

In some embodiments, if no tuples and/or records in one or more data repositories in a higher-level deployment environment associated with one or more one or more application modules modified by the code version control protocol are determined, such as scenarios where there is no corresponding mapping between the code version control protocol and the higher-level deployment environment (e.g., a framework is missing)), then the system may trigger an error message. By identifying a first dataset, the present disclosure is configured to only select tuples and/or data records which are relevant for testing the code changes because the data is associated with one or more application modules actually revised by the code changes. By identifying this narrow first dataset, the present disclosure conserves computing resources and minimizes the size of created datasets, further expediting the testing component of a continuous-improvement development framework.

In some embodiments, the data deployment package protocol comprises determining a second dataset based on the one or more application modules and the first dataset, wherein the second dataset comprises the deployment environment data modified in at least two of the one or more application modules and deployment environment error data. In some embodiments, the AI engine may evaluate data in the deployment environment to identify a cross-section of the one or more application modules to determine if deployment environment data is modified, impacted, and/or present within at least two of the one or more application modules. The second dataset may comprise a superset of all rows of deployment environment data modified in the at least two of the one or more application modules, according to some embodiments. The second dataset may be generated by aggregating the deployment environment error data with the superset and/or deployment environment data modified in at least two of the one or more application modules. In addition, a second threshold may be utilized to determine the second dataset, whereby the second threshold may be associated with a security criticality, part of a code revision control protocol request, error frequency, and/or the like, and the second threshold may be determined by AI engine, predetermined by a device associated with a developer, and/or by user request.

In some embodiments, the data deployment package protocol comprises identifying a third dataset associated with the second dataset. In some embodiments, the third dataset may comprise a second subset of the deployment environment data associated with the one or more application modules modified by the code version control protocol, wherein the second subset may comprise a data schema that may be transposed in relation to the first dataset, and/or the third dataset may comprise a data schema that may be transposed in relation to the second dataset. In some embodiments, the third dataset comprises one or more columns and/or data lists from data repositories in the deployment environment data associated with the one or more application modules modified by the code version control protocol. In some embodiments, the third dataset may be aggregated by the AI engine and/or stored in a third dataset intermediary data depository, such as a staging table, database, data lake, and/or the like.

In some embodiments, the data deployment package protocol may comprise selecting a deployment environment dataset based on a reference matrix, the first dataset, the second dataset, and the third dataset. In some embodiments, selecting a deployment environment dataset may comprise at least one of the reference matrix, the first dataset, the second dataset, and the third dataset. In some embodiments, the AI engine may dynamically determine which of the reference matrix, the first dataset, the second dataset, and/or the third dataset to utilize to select the deployment environment dataset.

In some embodiments, the reference matrix comprises a table, data schema, and/or the like comprising an identifier associated with the one or more application modules modified by the code version control protocol and/or one or more records and/or rows for each one or more application modules modified by the code version control protocol. In some embodiments, the reference matrix may be utilized to validate data populated in the data mapping matrix. By way of non-limiting example, and in some embodiments, the AI engine may access the reference matrix, query the reference matrix based on the code version control protocol and/or deployment environment data scan, retrieve the query results, and/or compare the query results to the data mapping matrix. In some embodiments, the reference matrix, the first dataset, the second dataset, and/or the third dataset may yield the deployment environment dataset by determining an intersecting, overlapping dataset (i.e., the deployment environment dataset) by determining a subset of all data in the deployment environment that is impacted across each one or more application modules by the coder version control protocol and/or all data that overlaps and/or intersects between the reference matrix, the first dataset, the second dataset, and/or the third dataset.

In some embodiments, the data deployment package protocol may comprise generating and executing a query, using the AI engine, to generate the deployment data package based on the deployment environment dataset. Upon identifying the deployment environment dataset by evaluating the reference matrix, the first dataset, the second dataset, and/or the third dataset, the AI engine may generate a query and may execute the query to create a matching dataset as a backup and/or dataset suitable for extracting and transmission to one or more lower-level deployment environments. In some embodiments, generating and executing the query may comprise compiling data and metadata associated with the deployment environment, one or more lower-level deployment environments, the code version control protocol, and/or the like to determine how to generate the deployment data package. In some embodiments, the data deployment package protocol may comprise determining a target data format for the data deployment package and/or executing a format change of the deployment environment dataset for use in the one or more lower-level deployment environments. According to some embodiments, the data deployment package protocol may comprise filtering data, masking sensitive data (e.g. obfuscating personally identifying data, names, account numbers, phone numbers, and/or the like via encryption, hashing, and/or random substitution), and/or executing data processing to ensure data integrity and to cleanse inconsistent and/or invalid data.

As shown in block 412, the process flow 400 may include the step of transmitting the data deployment package to one or more deployment environments. In some embodiments, transmitting to the data deployment package to one or more deployment environments may comprise transmitting the data deployment package to the one or more lower-level deployment environments dynamically, via scheduled job, and/or via request of a developer associated with the code version control protocol. According to some embodiments, transmitting the data deployment package to one or more deployment environments may comprise transmitting a confirmation message to a network device in the one or more lower-level deployment environments to confirm success of the transmission of the data deployment package and may comprise receiving a confirmation message from the network device. In some embodiments, transmitting the data deployment package to one or more deployment environments may comprise generating a responsive success message to a user device associated with the developer associated with the code version control protocol, end user, software tester, system administrator, and/or the like. In some embodiments, the data deployment package may be transmitted via ETL processing and/or via manual intervention due to unavailability of an automated data transmission process, failed previous data deployment package transmission, and/or the like.

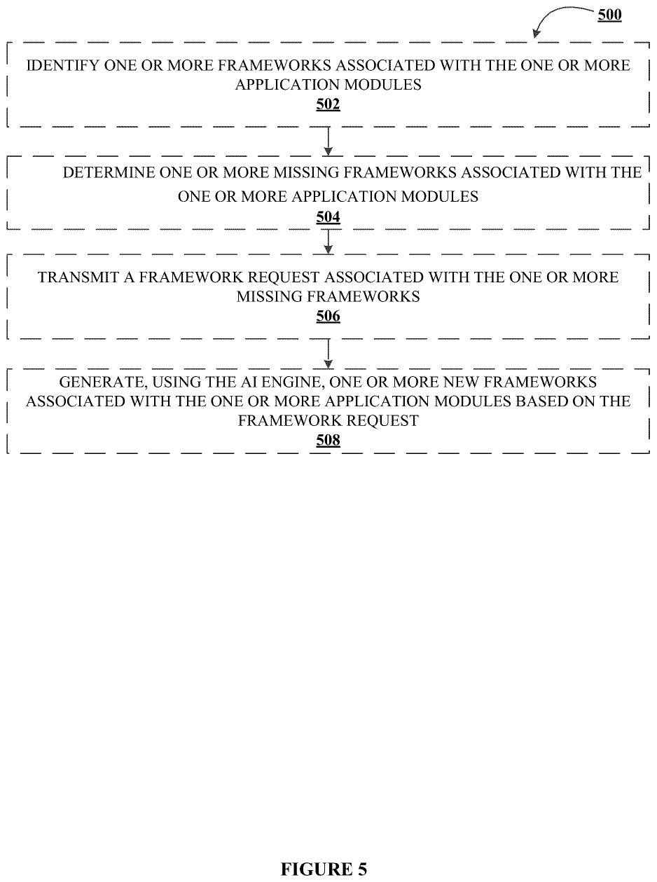

FIG. 5 illustrates a process flow 500 for identifying and generating frameworks associated with the one or more application modules, in accordance with an embodiment of the disclosure. In some embodiments, a system (e.g., similar to one or more of the systems described herein with respect to FIGS. 1A-1C) may perform one or more of the steps of process flow 500. For example, data package generation in deployment environments using AI system (e.g., the system 130 described herein with respect to FIGS. 1A-1C) may perform the steps of process flow 500. In some embodiments, an AI engine (e.g., such as the AI engine like that described in FIG. 2) or a generative AI subsystem (e.g., such as the generative AI subsystem described in FIG. 3) may perform some or all of the steps described in process flow 500.

As shown in block 502, the process flow 500 may include the step of identifying one or more frameworks associated with the one or more application modules. According to some embodiments, identifying one or more frameworks associated with the one or more application modules may comprise executing a query (by the system and/or AI engine) to query one or more internal repositories based on the code version control protocol. The query results may comprise network topology maps, mapping matrices associated with the one or more application frameworks, data schema diagrams, and/or the like.

In some embodiments, the one or more frameworks may comprise one or more connections associated with a first one or more data fields in a first database and a second one or more data fields in a second database. According to some embodiments, the one or more frameworks may comprise a network architecture framework mapping interdependencies between the one or more application modules, databases associated with the one or more application modules, and/or network services associated with the one or more application modules. The one or more frameworks may comprise data schema, data table logic, automated data mapping templates, and/or the like, in some embodiments. The one or more frameworks may determine how data records, databases, one or more application modules, and/or deployment environments (e.g., higher level, lower-level, production, quality assurance, and/or development) are associated, and how the proposed code revisions, via the code version control protocol, may impact the data records, databases, and/or one or more application modules.

As shown in block 504, the process flow 500 may include the step of determining one or more missing frameworks associated with the one or more application modules. In some embodiments, the query may return no results and/or outdated frameworks no longer applicable to current deployment environments. In such configurations, and in some embodiments, the system and/or AI engine may determine that there are one or more missing frameworks associated with the one or more application modules. When one or more frameworks are missing, the system may not be able to execute the deployment environment data scan, determining one or more application modules modified by the code version control protocol, data mapping matrix protocol, and/or data deployment package protocol due to the lack of mapping between data fields, databases, data sources, application modules, and/or deployment environments. The AI engine may determine one or more missing frameworks associated with the one or more application modules, according to some embodiments.

As shown in block 506, the process flow 500 may include the step of transmitting a framework request associated with the one or more missing frameworks. According to some embodiments, the framework request may comprise a request to a database administrator, system administrator, software developer, and/or AI engine to generate one or more new frameworks. The framework request may comprise proposed code revisions from the code version control protocol, known data sources, known databases, one or more application modules, requested deadline, and/or the like.

As shown in block 508, the process flow 500 may include the step of generating, using the AI engine, one or more new frameworks associated with the one or more application modules based on the framework request. According to some embodiments, the one or more new frameworks associated with the one or more application modules based on the framework request may comprise network topology maps, mapping matrices, data schema diagrams, one or more connections associated with a first one or more data fields in a first database and a second one or more data fields in a second database, and/or a network architecture framework mapping interdependencies between the one or more application modules, databases associated with the one or more application modules, and/or network services associated with the one or more application modules. In some embodiments, the one or more new frameworks may comprise data schema logic, data table logic, and/or automated data mapping templates to determine how data records, databases, one or more application modules, and/or deployment environments (e.g., higher level, lower-level, production, quality assurance, and/or development) are associated, and how the proposed code revisions, via the code version control protocol, may impact the data records, databases, and/or one or more application modules. By establishing the one or more new frameworks, the system ensures data integrity, accurate mapping of the deployment environments, and minimizes errors due to a lack of frameworks.

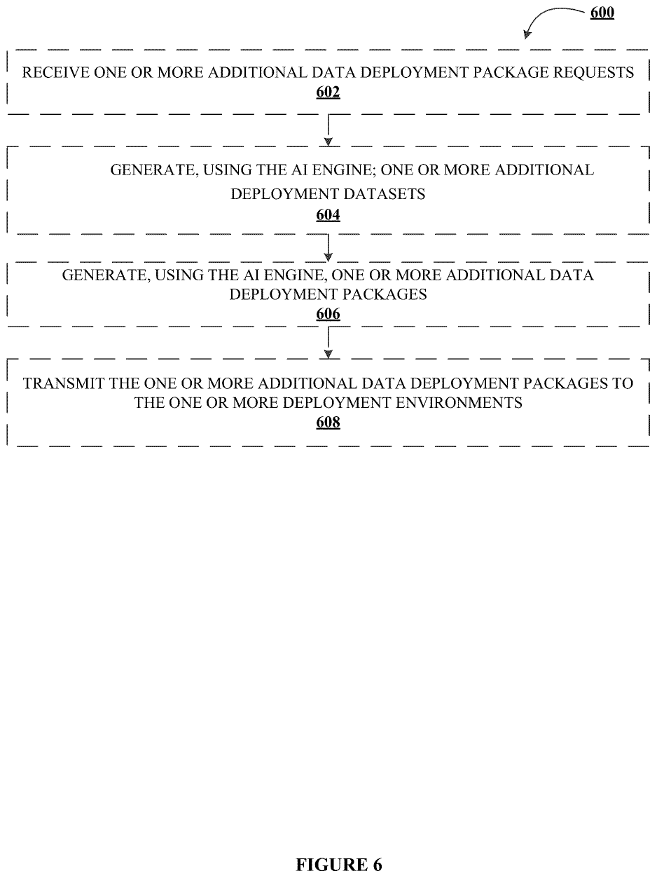

FIG. 6 illustrates a process flow 600 for generating one or more additional data deployment packages, in accordance with an embodiment of the disclosure. In some embodiments, a system (e.g., similar to one or more of the systems described herein with respect to FIGS. 1A-1C) may perform one or more of the steps of process flow 600. For example, data package generation in deployment environments using AI system (e.g., the system 130 described herein with respect to FIGS. 1A-1C) may perform the steps of process flow 600. In some embodiments, an AI engine (e.g., such as the AI engine like that described in FIG. 2) or a generative AI subsystem (e.g., such as the generative AI subsystem described in FIG. 3) may perform some or all of the steps described in process flow 600.

As shown in block 602, the process flow 600 may include the step of receiving one or more additional data deployment package requests. According to some embodiments, additional data from the deployment environment may be necessary for testing code revisions in one or more lower-level environments. In such configurations, the data deployment package may fail or be inadequate due to additional code revisions, subsequent refresh of data in the deployment environment, failed testing uses cases and/or scenarios after initial tests of the submitted code change, and/or the like. When this may occur, one or more additional data deployment package requests may be generated and transmitted by a developer, system administrator, network device associated with a tester, and/or the like. The one or more additional data deployment package requests may comprise a descriptor associated with the request for additional training data, one or more application modules impacted by changed code and/or failed test cases, a target deadline for fulfilling the one or more additional data deployment package requests, a date range associated with additional deployment environment datasets, filters associated with the additional deployment environment datasets, and/or the like.

As shown in block 604, the process flow 600 may include the step of generating, using the AI engine, one or more additional deployment datasets. In some embodiments, the AI engine may parse the one or more additional data deployment package requests using a natural language processing (NLP) algorithm to extract one or more additional deployment package data and/or metadata associated with the one or more additional deployment data package requests. Based upon the one or more additional deployment package data and/or metadata associated with the one or more additional deployment data package requests, the AI engine may initiate, trigger and/or execute one or more additional code version control protocols, deployment environment data scans, data mapping matrix protocols, and/or to generate the one or more additional deployment datasets.

As shown in block 606, the process flow 600 may include the step of generating, using the AI engine, one or more additional data deployment packages. According to some embodiments, generating, using the AI engine, one or more additional data deployment packages may comprise executing one or more additional data package deployment protocols. In some embodiments, the one or more additional data package deployment protocols may be executed in series, parallel, and/or the like. In some embodiments, the AI engine may prioritize an order of executing the one or more additional data package deployment protocols based on the one or more additional data deployment package requests.

As shown in block 608, the process flow 600 may include the step of transmitting the one or more additional data deployment packages to the one or more deployment environments. In some embodiments, transmitting to one or more additional data deployment packages to the one or more deployment environments may comprise transmitting the one or more additional data deployment packages to the one or more lower-level deployment environments dynamically, via scheduled job, and/or via request of a developer associated with the one or more additional data deployment package requests. According to some embodiments, transmitting the one or more additional data deployment packages to one or more deployment environments may comprise transmitting a confirmation message to a network device in the one or more lower-level deployment environments to confirm success of the transmission of the one or more additional data deployment packages and may comprise receiving a responsive confirmation message from the network device. In some embodiments, transmitting the one or more additional data deployment packages to one or more deployment environments may comprise generating a success message to a user device associated with the developer associated one or more additional data deployment package requests, end user, software tester, system administrator, and/or the like. In some embodiments, the one or more additional data deployment packages may be transmitted via ETL processing and/or via manual intervention due to unavailability of an automated data transmission process, failed previous data deployment package transmissions, and/or the like. By facilitating and executing the one or more additional data deployment package requests, the system provides further enhancements to providing effective testing datasets while preserving computing resources. By way of non-limiting example, and in some embodiments, by generating targeted datasets associated with each one or more additional data deployment package requests, rather than copying entire deployment environments for each request, the system saves computing resources associated with the dataset generation, preserves network bandwidth in transmitting the datasets, and provides more accurate testing resources for new code changes.

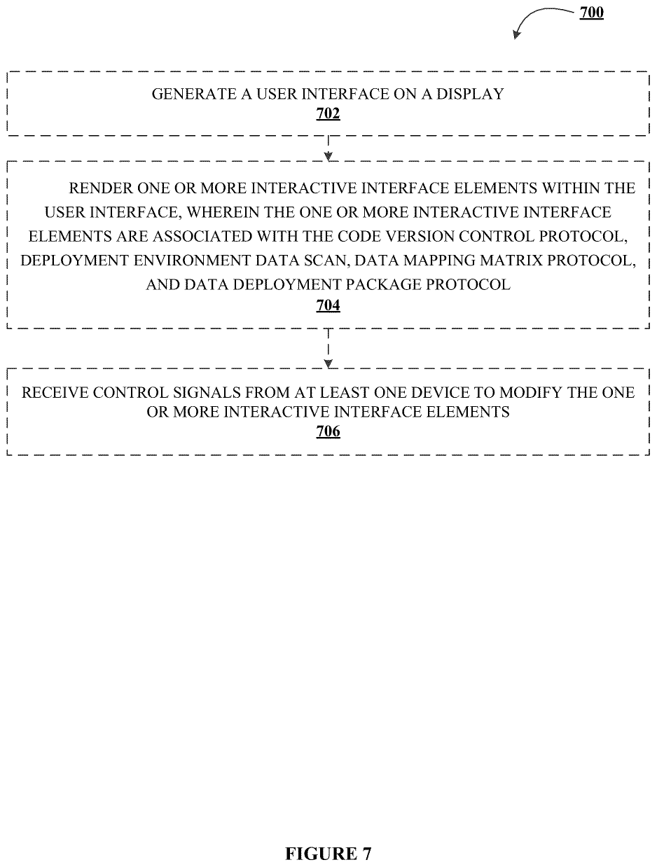

FIG. 7 illustrates a process flow 700 for rendering and modifying one or more interactive interface elements, in accordance with an embodiment of the disclosure. In some embodiments, a system (e.g., similar to one or more of the systems described herein with respect to FIGS. 1A-1C) may perform one or more of the steps of process flow 700. For example, data package generation in deployment environments using AI system (e.g., the system 130 described herein with respect to FIGS. 1A-1C) may perform the steps of process flow 700. In some embodiments, an AI engine (e.g., such as the AI engine like that described in FIG. 2) or a generative AI subsystem (e.g., such as the generative AI subsystem described in FIG. 3) may perform some or all of the steps described in process flow 700.

As shown in block 702, the process flow 700 may include the step of generating a user interface on a display. According to some embodiments, the user interface may be disposed within a display device, mixed reality headset, projector system, mobile device, glasses, and/or the like. The user interface may comprise input devices and output devices, including without limitation physical buttons, capacitive touch buttons, digital icons and buttons, audio transmitter, audio receiver, microphone, speaker, and/or headphones, according to some embodiments.

As shown in block 704, the process flow 700 may include the step of rendering one or more interactive interface elements within the user interface, wherein the one or more interactive interface elements within the user interface are associated with the code version control protocol, deployment environment data scan, data mapping matrix protocol, and data deployment package protocol. According to some embodiments, the one or more interactive interface elements may comprise menus, icons, digital buttons, digital objects, and/or the like. In some embodiments, the one or more interactive elements may comprise dashboards associated with the code version control protocol, deployment environment data scan, data mapping matrix protocol, data deployment package protocol, data deployment package, framework request, one or more frameworks associated with the one or more application modules, network packet anomaly data, an anomaly, and/or anomaly remediation. The one or more interactive elements may activate upon selection, interaction, and/or input from the user, according to some embodiments.

As shown in block 706, the process flow 700 may include the step of receiving control signals from at least one device to modify the one or more interactive interface elements. According to some embodiments, the control signals may be associated with input devices, mobile device, one or more network devices, the interactive interface elements, microphone, audio transmitter, and/or the like. By way of non-limiting example, and in some embodiments, a user may interact with the one or more interactive interface elements, which may generate control signals. According to some embodiments, the control signals may be associated with the code version control protocol, deployment environment data scan, data mapping matrix protocol, data deployment package protocol, data deployment package, framework request, one or more frameworks associated with the one or more application modules, network packet anomaly data, an anomaly, and/or anomaly remediation, and/or the like.

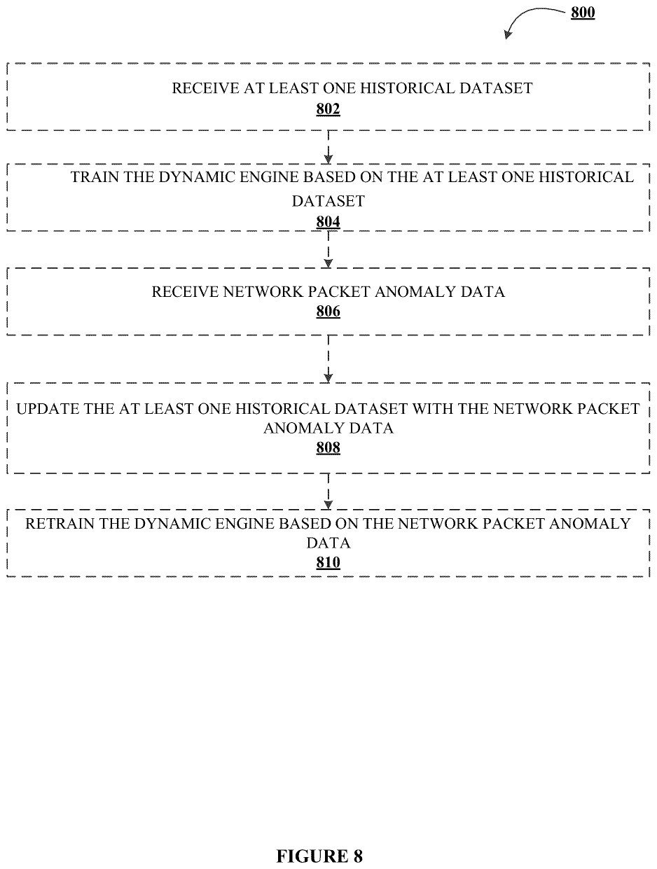

FIG. 8 illustrates a process flow 800 for training and retraining the AI engine, in accordance with an embodiment of the disclosure. In some embodiments, a system (e.g., similar to one or more of the systems described herein with respect to FIGS. 1A-1C) may perform one or more of the steps of process flow 800. For example, data package generation in deployment environments using AI system (e.g., the system 130 described herein with respect to FIGS. 1A-1C) may perform the steps of process flow 800. In some embodiments, an AI engine (e.g., such as the AI engine like that described in FIG. 2) or a generative AI subsystem (e.g., such as the generative AI subsystem described in FIG. 3) may perform some or all of the steps described in process flow 800.

As shown in block 802, the process flow 800 may include the step of receiving at least one historical dataset. The at least one historical dataset may be stored in an internal data repository, hosted externally by an external network administrator, and/or the like. In some embodiments, the system may collect, compile, and/or aggregate historical data to create the at least one historical dataset and may store the at least one historical dataset in an internal data repository. In such a configuration, the system may access and retrieve the at least one historical dataset each time the AI engine may be trained, wherein the AI engine may comprise AI model, generative AI model, AI application, and/or the like. In some embodiments, the system may receive the at least one historical dataset continuously, at set internals, and/or via on-demand request generated by the AI engine, a user, an AI engine training controller, network device, and/or the like. In some embodiments, the system may receive the entire at least one historical dataset. According to sone embodiments, the system may only receive a subset of data contained within the at least one historical dataset based on training requirements associated with an AI engine training request generated by the system, user, network device, and/or the like. By training the AI engine on only a subset of the at least one historical dataset based on the most material and/or relevant data, the system may conserve computing resources, minimize energy expenditures, and/or enhance the AI engine performance. In some embodiments, the subset of data may not comprise sensitive data, preventing the inclusion of sensitive data in training the AI engine, which enhances data security and privacy.

As shown in block 804, the process flow 800 may include the step of training the AI engine based on the at least one historical dataset. In some embodiments, the at least one historical dataset comprises historical code version control protocols, historical deployment environment data scans, historical data mapping matrix protocols, historical data deployment package protocols, historical data deployment packages, historical framework requests, historical one or more frameworks associated with the one or more application modules, historical network packet anomaly data, historical anomalies, and/or historical anomaly remediations, historical control signals, and/or the like. In some embodiments, the AI engine may comprise a generative AI model, in which training the generative AI model may comprise ingesting the historical dataset, adjusting parameters in response to generative AI model output, evaluating the model for fine-tuning, and/or deploying the generative AI model.

As shown in block 806, the process flow 800 may include the step of receiving network packet anomaly data. In some embodiments, receiving the network packet anomaly data may comprise receiving network data packets comprising network packet anomaly data. In some embodiments, a data aggregator may collect network packet anomaly data to generate aggregated network packet anomaly data and transmit the aggregated network packet anomaly data via network data packets to the system and/or AI engine. In some embodiments, the data aggregator may pre-process the network packet anomaly data, such as data cleansing, encrypting, and/or executing an ETL process. In some embodiments, the system may process the received network data packets, such as executing decryption, data extraction, and/or the like.

As shown in block 808, the process flow 800 may include the step of updating the at least one historical dataset with the network packet anomaly data. In some embodiments, the network packet anomaly data may be attached to the at least one historical dataset. In such a configuration, an ETL process may be executed to transmit the network packet anomaly data dataset to the same data storage repository as the at least one historical dataset. In some embodiments, updating the at least one historical dataset with the network packet anomaly data may occur via the AI engine, may occur dynamically, via batch processing at set intervals, and/or based on a request associated with a network device.

As shown in block 810, the process flow 800 may include the step of retraining the AI engine based on the network packet anomaly data. The retraining step may be executed via feedback loop for continuous retraining and/or the retraining may occur via internal-based batch jobs, according to some embodiments. In some embodiments, the AI engine may refine itself by revising its weights and other such decision factors to improve accuracy, speed, and minimize errors, based on a AI engine training confidence threshold. In some embodiments, the system may determine the AI engine training confidence threshold, and if the AI engine training confidence threshold is below a given confidence threshold (e.g., predetermined, determined via notification from a network device, and/or dynamically determined by the system), the system may trigger retraining of the AI engine. In some embodiments, if criteria (e.g., code version control protocol, deployment environment data scan, data mapping matrix protocol, data deployment package protocol, data deployment package, framework request, one or more frameworks associated with the one or more application modules, network packet anomaly data, an anomaly, and/or anomaly remediation, and/or the like) and/or network packet anomaly data are generated and/or received by the system and/or AI engine (hereinafter referred to as “new training factors”), then the system and/or AI engine may trigger in real-time retraining of the AI engine based on the new training factors. By constantly monitoring for new training factors and triggering a responsive real-time retraining, the system provides a technical solution to the challenge of monitoring new training factors and changing network traffic conditions and adjusting the system dynamically.

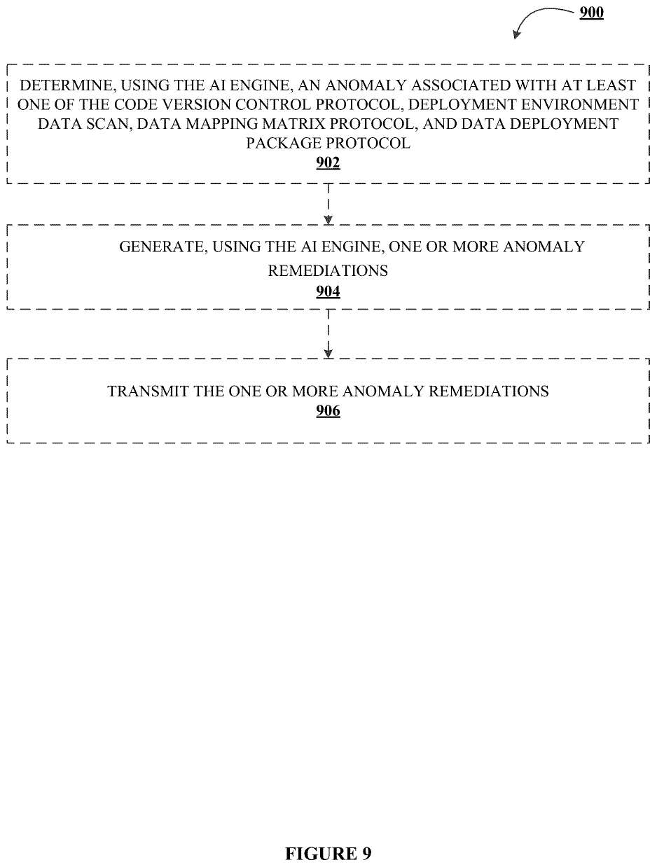

FIG. 9 illustrates a process flow 900 for determining anomalies and anomaly remediations using the AI engine, in accordance with an embodiment of the disclosure. In some embodiments, a system (e.g., similar to one or more of the systems described herein with respect to FIGS. 1A-1C) may perform one or more of the steps of process flow 900. For example, data package generation in deployment environments using AI system (e.g., the system 130 described herein with respect to FIGS. 1A-1C) may perform the steps of process flow 900. In some embodiments, an AI engine (e.g., such as the AI engine like that described in FIG. 2) or a generative AI subsystem (e.g., such as the generative AI subsystem described in FIG. 3) may perform some or all of the steps described in process flow 900.

As shown in block 902, the process flow 900 may include the step of determining, using the AI engine, an anomaly associated with at least one of the code version control protocol, deployment environment data scan, data mapping matrix protocol, and data deployment package protocol. In some embodiments, an anomaly associated with the code version control protocol may comprise malicious code, code comprising programming errors, spyware, malware, SQL injections, distributed denial-of-service attacks, corrupted code, corrupted executables associated with code revisions, code revisions submitted by an unauthenticated developer, and/or the like.

An anomaly associated with deployment environment data scan may comprise corrupted data, failed data scans, abnormal network traffic patterns and/or traffic spikes, data transfers at high volumes during unexpected time periods, network latency changes, error messages above predetermined thresholds, deployment environment failures above a predetermined threshold, unknown network data packets, unauthorized network data scans, and/or the like. An anomaly associated with the data mapping matrix protocol applications errors determined by the AI engine associated with the one or more application modules targeted by the code version control protocol, failure to generate the data mapping matrix, one or more missing identifiers associated with the one or more application modules, one or more missing descriptors associated with the code version control protocol, and/or failure to populate the data mapping matrix.

In some embodiments, an anomaly associated with the data deployment package protocol may comprise a failure to determine the first dataset, second dataset, third dataset, and/or deployment environment dataset; failure to generate and execute a query to generate the deployment data package; and/or failure to transmit the deployment data package. Anomalies associated with the data deployment package protocol may be caused by unauthenticated network devices and/or users, deployment environment failures, timeouts associated with errors associated with generating and executing the query, and/or the like. In some embodiments, the AI engine may determine the anomaly dynamically based on real-time network traffic flow, via trigger (such as user request), and/or at set intervals via batch processing.

As shown in block 904, the process flow 900 may include the step of generating, using the AI engine, one or more anomaly remediations. According to some embodiments, the one or more anomaly remediations may comprise corrective responsive actions to mitigate the anomaly. In some embodiments, the AI engine may prioritize the corrective responsive actions based on the anomaly. In some embodiments, prioritization may be necessary based on the identified anomaly, the security threat associated with the anomaly, and/or the complexity in generating and executing the one or more anomaly remediations. The one or more anomaly remediations may comprise shutting down a network edge associated with the anomaly, shutting down a network, restricting intra-network and/or inter-network transmissions, restricting transmissions between deployment environments, partitioning at least one network into subnets for revising network traffic flow, shutting down network ports, opening additional network ports, requiring re-authenticating and re-authorizing access of a user and/or network device, revoking authorization, revoking access, implementing additional authorization and/or authentication requirements (e.g., multifactor authentication), increasing security requirements, updating software to implement security patches, executing maintenance on network devices, revising code to remove malicious code and/or programming errors, reattempting the code version control protocol and/or deployment environment data scan and/or data mapping matrix and/or data deployment package protocol, and/or the like. In some embodiments, the AI engine may determine the one or more anomaly remediations dynamically based on real-time network traffic flow, via trigger (such as user request and/or detection of an anomaly), and/or at set intervals via batch processing.

As shown in block 906, the process flow 900 may include the step of transmitting the one or more anomaly remediations. In some embodiments, transmitting the one or more anomaly remediations may comprise transmitting network data packets, text message, email, instant message, audio transmissions, video transmissions, alert via user interface, and/or push notification to a mobile device. According to some embodiments, the one or more anomaly remediations may be transmitted via communication channel and/or via ETL and/or file transfer protocol, may comprise end-to-end encryption, a secure socket layer, transport layer security, and/or the like. According to some embodiments, the AI engine may transmit and/or execute the one or more anomaly remediations to mitigate vulnerabilities associated with the anomaly, and/or may transmit success and/or failure messages of executing the one or more anomaly remediations.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for data package generation in deployment environments using artificial intelligence (AI), the system comprising:
a memory device with computer-readable program code stored thereon;
at least one processing device, wherein executing the computer-readable program code is configured to cause the at least one processing device to execute the computer-readable program code to:
execute a code version control protocol on one or more code repositories;
determine one or more application modules modified by the code version control protocol;
execute, using an AI engine, a deployment environment data scan based on the code version control protocol, wherein the deployment environment data scan comprises deployment environment data;
execute a data mapping matrix protocol based on the code version control protocol and the deployment environment data scan;
execute, using the AI engine, a data deployment package protocol based on the data mapping matrix protocol, wherein the data deployment package protocol comprises a data deployment package; and
transmit the data deployment package to one or more deployment environments.

2. The system of claim 1, wherein the code version control protocol comprises:
receiving a code version control protocol request; determining code package deployments based on a code release schedule; monitoring the one or more code repositories for changed code; and detecting new code packages based on at least one of the code version control protocol request, code package deployments, and the new code packages.

3. The system of claim 1, wherein the deployment environment data scan further comprises:
scanning, using the AI engine, one or more datasets associated with the one or more application modules, wherein the AI engine comprises a generative AI model; identifying, using the AI engine, internal data repository code changes based on the code version control protocol; and determining, using the AI engine, code execution procedures from memory, error logs associated with deployment environment failures, and metadata associated with deployment environment failures.

4. The system of claim 1, wherein the data mapping matrix protocol comprises:
determining one or more records modified by the one or more application modules targeted by the code version control protocol; generating a data mapping matrix; and populating the data mapping matrix with matrix data, wherein the matrix data comprises an identifier associated with the one or more application modules and a descriptor associated with the code version control protocol.

5. The system of claim 1, wherein executing the computer-readable program code is further configured to cause the at least one processing device to:
identify one or more frameworks associated with the one or more application modules;
determine one or more missing frameworks associated with the one or more application modules;
transmit a framework request associated with the one or more missing frameworks; and
generate, using the AI engine, one or more new frameworks associated with the one or more application modules based on the framework request.

6. The system of claim 1, wherein executing the computer-readable program code is further configured to cause the at least one processing device to:
receive one or more additional data deployment package requests;
generate, using the AI engine, one or more additional deployment datasets;
generate, using the AI engine, one or more additional data deployment packages; and
transmit the one or more additional data deployment packages to the one or more deployment environments.

7. The system of claim 1, wherein executing the computer-readable program code is further configured to cause the at least one processing device to:
generate a user interface on a display;
render one or more interactive interface elements within the user interface, wherein the one or more interactive interface elements within the user interface are associated with the code version control protocol, deployment environment data scan, data mapping matrix protocol, and data deployment package protocol; and
receive control signals from at least one device to modify the one or more interactive interface elements.

8. The system of claim 1, wherein executing the computer-readable program code is further configured to cause the at least one processing device to:
receive at least one historical dataset;
train the AI engine based on the at least one historical dataset;
receive network packet anomaly data;
update the at least one historical dataset with the network packet anomaly data; and
retrain the AI engine based on the network packet anomaly data.

9. The system of claim 1, wherein executing the computer-readable program code is further configured to cause the at least one processing device to:
determine, using the AI engine, an anomaly associated with at least one of the code version control protocol, deployment environment data scan, data mapping matrix protocol, and data deployment package protocol;
generate, using the AI engine, one or more anomaly remediations; and
transmit the one or more anomaly remediations.

10. The system of claim 1, wherein the data deployment package protocol further comprises:
determining, using the AI engine, a first dataset based on the data mapping matrix protocol and a threshold, wherein the first dataset comprises a subset of the deployment environment data associated with the one or more application modules modified by the code version control protocol; determining a second dataset based on the one or more application modules and the first dataset, wherein the second dataset comprises the deployment environment data modified in at least two of the one or more application modules and deployment environment error data; identifying a third dataset associated with the second dataset; selecting a deployment environment dataset based on a reference matrix, the first dataset, the second dataset, and the third dataset; and generating and executing a query, using the AI engine, to generate the deployment data package based on the deployment environment dataset.

11. A computer program product for data package generation in deployment environments using artificial intelligence (AI), wherein the computer program product comprises at least one non-transitory computer-readable medium having computer-readable program code portion embodied therein, the computer-readable program code portions which when executed by a processing device are configured to cause a processor to:
execute a code version control protocol on one or more code repositories;
determine one or more application modules modified by the code version control protocol;
execute, using an AI engine, a deployment environment data scan based on the code version control protocol, wherein the deployment environment data scan comprises deployment environment data;
execute a data mapping matrix protocol based on the code version control protocol and the deployment environment data scan;
execute, using the AI engine, a data deployment package protocol based on the data mapping matrix protocol, wherein the data deployment package protocol comprises a data deployment package; and
transmit the data deployment package to one or more deployment environments.

12. The computer program product of claim 11, wherein the code version control protocol comprises:
receiving a code version control protocol request; determining code package deployments based on a code release schedule; monitoring the one or more code repositories for changed code; and detecting new code packages based on at least one of the code version control protocol request, code package deployments, and the new code packages.

13. The computer program product of claim 11, wherein the deployment environment data scan further comprises:
scanning, using the AI engine, one or more datasets associated with the one or more application modules, wherein the AI engine comprises a generative AI model; identifying, using the AI engine, internal data repository code changes based on the code version control protocol; and determining, using the AI engine, code execution procedures from memory, error logs associated with deployment environment failures, and metadata associated with deployment environment failures.

14. The computer program product of claim 11, wherein the data mapping matrix protocol comprises:
determining one or more records modified by the one or more application modules targeted by the code version control protocol; generating a data mapping matrix; and populating the data mapping matrix with matrix data, wherein the matrix data comprises an identifier associated with the one or more application modules and a descriptor associated with the code version control protocol.

15. The computer program product of claim 11, wherein the data deployment package protocol further comprises:
determining, using the AI engine, a first dataset based on the data mapping matrix protocol and a threshold, wherein the first dataset comprises a subset of the deployment environment data associated with the one or more application modules modified by the code version control protocol; determining a second dataset based on the one or more application modules and the first dataset, wherein the second dataset comprises the deployment environment data modified in at least two of the one or more application modules and deployment environment error data; identifying a third dataset associated with the second dataset; selecting a deployment environment dataset based on a reference matrix, the first dataset, the second dataset, and the third dataset; and generating and executing a query, using the AI engine, to generate the deployment data package based on the deployment environment dataset.

16. A computer-implemented method for data package generation in deployment environments using artificial intelligence (AI):
executing a code version control protocol on one or more code repositories;
determining one or more application modules modified by the code version control protocol;
executing, using an AI engine, a deployment environment data scan based on the code version control protocol, wherein the deployment environment data scan comprises deployment environment data;
executing a data mapping matrix protocol based on the code version control protocol and the deployment environment data scan;
executing, using the AI engine, a data deployment package protocol based on the data mapping matrix protocol, wherein the data deployment package protocol comprises a data deployment package; and
transmitting the data deployment package to one or more deployment environments.

17. The computer-implemented method of claim 16, wherein the code version control protocol comprises:
receiving a code version control protocol request; determining code package deployments based on a code release schedule; monitoring the one or more code repositories for changed code; and detecting new code packages based on at least one of the code version control protocol request, code package deployments, and the new code packages.

18. The computer-implemented method of claim 16, wherein deployment environment data scan further comprises:
scanning, using the AI engine, one or more datasets associated with the one or more application modules, wherein the AI engine comprises a generative AI model; identifying, using the AI engine, internal data repository code changes based on the code version control protocol; and determining, using the AI engine, code execution procedures from memory, error logs associated with deployment environment failures, and metadata associated with deployment environment failures.

19. The computer-implemented method of claim 16, the data mapping matrix protocol comprises:
determining one or more records modified by the one or more application modules targeted by the code version control protocol; generating a data mapping matrix; and populating the data mapping matrix with matrix data, wherein the matrix data comprises an identifier associated with the one or more application modules and a descriptor associated with the code version control protocol.

20. The computer-implemented method of claim 16, wherein the data deployment package protocol further comprises:
determining, using the AI engine, a first dataset based on the data mapping matrix protocol and a threshold, wherein the first dataset comprises a subset of the deployment environment data associated with the one or more application modules modified by the code version control protocol; determining a second dataset based on the one or more application modules and the first dataset, wherein the second dataset comprises the deployment environment data modified in at least two of the one or more application modules and deployment environment error data; identifying a third dataset associated with the second dataset; selecting a deployment environment dataset based on a reference matrix, the first dataset, the second dataset, and the third dataset; and generating and executing a query, using the AI engine, to generate the deployment data package based on the deployment environment dataset.
